(19) United States
(12) Patent Application Publication
(10) Pub. No.: US 2008/0247797 A1
(43) Pub. Date: Oct. 9, 2008

(54) Recording Medium Deburring Apparatus and Image Forming Apparatus

(75) Inventors: Daisuke Yoshino, Ashigarakami-gun (JP); Atsumi Kurita, Ashigarakami-gun (JP); Yasuhiro Uehara, Ashigarakami-gun (JP); Junpei Amano, Ashigarakami-gun (JP); Aya Kakishima, Ashigarakami-gun (JP); Toshiyuki Miyata, Ashigarakami-gun (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/951,655

(22) Filed: Dec. 6, 2007

(30) Foreign Application Priority Data
Apr. 5, 2007 (JP) 2007-99518

(51) Int. Cl. G03G 15/00; B65H 5/00

(52) U.S. Cl. 399/406; 271/264

(57) ABSTRACT

The recording medium deburring apparatus is provided with: a transporting device that transports a recording medium; and a pressure applying device that applies pressure to edge portions of the recording medium. The edge portions are in parallel to a transporting direction of the recording medium transported by the transporting device.

### CROSS REFERENCE TO RELATED APPLICATIONS

This application is based on and claims priority under 35 USC §119 from Japanese Patent Application No. 2007-99518 filed Apr. 5, 2007.

### BACKGROUND

1. Technical Field

The present invention relates to a recording medium deburring apparatus and image forming apparatus.

2. Related Art

Some of the conventional-type image forming apparatuses are equipped with a leveling apparatus arranged in the course of the transporting route.

### SUMMARY

According to an aspect of the present invention, there is provided a recording medium deburring apparatus including: a transporting device that transports a recording medium; and a pressure applying device that applies pressure to edge portions of the recording medium, the edge portions being in parallel to a transporting direction of the recording medium transported by the transporting device.

### BRIEF DESCRIPTION OF THE DRAWINGS

Exemplary embodiment (s) of the present invention will be described in detail based on the following figures, wherein:

FIG. 1 shows an image forming apparatus to which the first exemplary embodiment is applied;

FIG. 2 shows general structure of the fixing unit;

FIG. 3A shows the paper-sheet deburring unit viewed from a direction that crosses the transporting direction of the paper sheet;

FIG. 3B shows the paper-sheet deburring unit viewed from the top thereof;

FIG. 3C shows the paper-sheet deburring unit viewed from the downstream side in the transporting direction of the paper sheet;

FIG. 4A shows the state in which the paper sheet passes between the first and the second rolls, each of which is a component part of the paper-sheet deburring unit;

FIG. 4B shows the state of one of the side-edge portions before the paper sheet passes through the paper-sheet deburring unit;

FIG. 4C shows the state of one of the side-edge portions after the paper sheet passes through the paper-sheet deburring unit;

FIG. 5A shows a paper-sheet deburring unit of the second exemplary embodiment viewed from a direction that crosses the transporting direction of a paper sheet;

FIG. 5B shows the paper-sheet deburring unit viewed from the top thereof;

FIG. 5C shows the paper-sheet deburring unit viewed from the downstream side in the transporting direction of the paper sheet;

FIGS. 6A and 6B are diagrams to describe the paper-sheet deburring operation in the paper-sheet deburring unit;

FIG. 7A shows a paper-sheet deburring unit of the third exemplary embodiment viewed from a direction that crosses the transporting direction of a paper sheet;

FIG. 7B shows the paper-sheet deburring unit viewed from the top thereof;

FIG. 7C shows the paper-sheet deburring unit viewed from the downstream side in the transporting direction of the paper sheet;

FIG. 8 is a diagram to describe the paper-sheet deburring operation in the paper-sheet deburring unit;

FIG. 9A shows a paper-sheet deburring unit of the fourth exemplary embodiment viewed from a direction that crosses the transporting direction of a paper sheet;

FIG. 9B shows the paper-sheet deburring unit viewed from the top thereof;

FIG. 9C shows the paper-sheet deburring unit viewed from the downstream side in the transporting direction of the paper sheet;

FIG. 10 is a diagram to describe the paper-sheet deburring operation in the paper-sheet deburring unit;

FIG. 11A shows a paper-sheet deburring unit of the fifth exemplary embodiment viewed from a direction that crosses the transporting direction of a paper sheet;

FIG. 11B shows the paper-sheet deburring unit viewed from the top thereof;

FIG. 11C shows the paper-sheet deburring unit viewed from the downstream side in the transporting direction of the paper sheet;

FIG. 12 is a diagram to describe the paper-sheet deburring operation carried out in the paper-sheet deburring unit;

FIG. 13A shows a paper-sheet deburring unit of the sixth exemplary embodiment viewed from a direction that crosses the transporting direction of a paper sheet;

FIG. 13B shows the paper-sheet deburring unit viewed from the top thereof;

FIG. 13C shows the paper-sheet deburring unit viewed from the downstream side in the transporting direction of the paper sheet;

FIG. 14 is a diagram to describe the paper-sheet deburring operation in the paper-sheet deburring unit;

FIG. 15 shows a paper-sheet deburring unit of a modified example of the sixth exemplary embodiment viewed from a direction that crosses the transporting direction of a paper sheet;

FIG. 16 is a graph showing the distribution of the pressure applied on the paper sheet by the paper-sheet deburring unit described in the first exemplary embodiment;

FIG. 17A is a table showing the evaluation results on the images by visual observation;

FIG. 17B is a graph showing the relationship between the surface pressure applied on the side-edge portions of the paper sheet and the reduced amount of the burrs;

FIG. 18A describes the case of the paper sheet before deburring, that is, before the paper sheet passes through the paper-sheet deburring unit; and

FIG. 18B describes the case of the paper sheet after the deburring.

### DETAILED DESCRIPTION

Detailed descriptions will be given below as to some preferred exemplary embodiments of the present invention (hereinafter, simply referred to as “exemplary embodiments”) with reference to the accompanying drawings.

### First Exemplary Embodiment

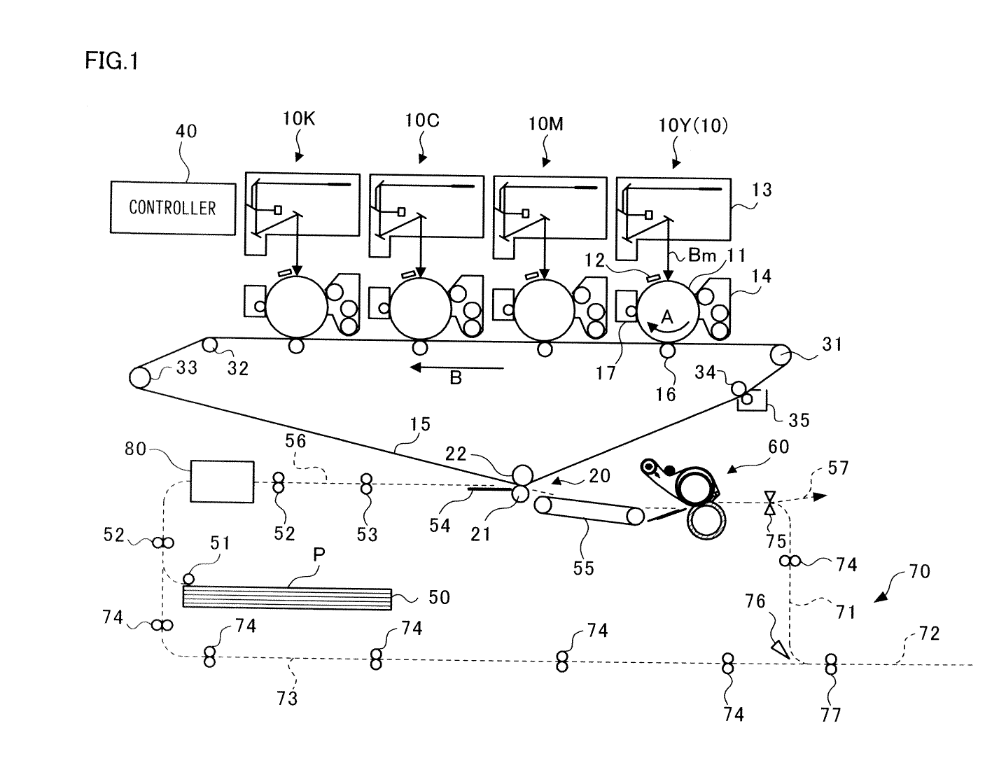

FIG. 1 shows an image forming apparatus to which the first exemplary embodiment is applied. The image forming apparatus shown in FIG. 1 is what is termed a tandem-type, or an intermediate-transfer-type image forming apparatus. The image forming apparatus includes multiple image forming units 10 (10Y, 10M, 10C, and 10K) in which toner images of each of color components are formed by electrophotographic manner. The image forming apparatus also includes an intermediate transferring belt 15 that sequentially transfers the toner images of those colors formed in the respective image forming units 10 and makes them held. Incidentally, this transferring process is called a primary transfer. In addition, the image forming apparatus includes a secondary transfer unit 20 in which the toner images having transferred to and superimposed on the intermediate transferring belt 15 are collectively transferred to a paper sheet P as an example of a recording medium. This process is called a secondary transfer. Moreover, the image forming apparatus includes a fixing unit 60, which makes the image having secondarily been transferred to the paper sheet P fixed thereon. Furthermore, the image forming apparatus includes a controller 40 to control the operation of the above-mentioned units and members.

Each of the image forming units 10 (10Y, 10M, 10C, and 10K) includes a photoconductor drum 11, a charging unit 12, a laser exposure unit 13, a developing unit 14, a primary transfer roll 16, and a cleaning unit 17. The photoconductor drum 11 has a photoconductor layer (not illustrated), and rotates in a direction as indicated by an arrow A in FIG. 1. The charging unit 12 makes the photoconductor layer of the photoconductor drum 11 electrically charged at a predetermined potential. The laser exposure unit 13 makes an electrostatic latent image formed on the electrically charged photoconductor drum 11 (an exposure beam is shown as a reference numeral Bm in FIG. 1). In the developing unit 14, the toner of each color component is stored and the toner is used to convert the electrostatic latent image into a visible image. By the primary transfer roll 16, the toner image having been formed in each color component on the photoconductor drum 11 is transferred to the intermediate transferring belt 15. The cleaning unit 17 removes the toner which remains on the photoconductor drum 11 after the transference is finished. Each of the image forming units 10 is formed substantially on a straight line, and the image forming units of yellow (10Y), magenta (10M), cyan (10C) and black (10K) are arranged in this order from the upstream side of the intermediate transferring belt 15.

The intermediate transferring belt 15 is made of a resin, such as a polyimide and a polyamide, to which an appropriate dose of an antistatic agent such as carbon black is added, and is a film-formed endless belt with a thickness of, for example, approximately 0.1 mm. The intermediate transferring belt 15 is driven to circulate at a predetermined velocity in a direction as indicated by an arrow B in FIG. 1 by a variety of rolls. These rolls include a drive roll 31, a supporting roll 32, a tension roll 33, a back-up roll 22 and a cleaning back-up roll 34. The drive roll 31 is driven by a motor (not illustrated in the figure) that is excellent in running with a constant speed, and drives to make the intermediate transferring belt 15 circulate. The supporting roll 32 supports the intermediate transferring belt 15, which extends in a substantially linear fashion along the direction in which the photoconductor drums 11 are arranged. The tension roll 33 gives certain tensile force to the intermediate transferring belt 15, and prevents the intermediate transferring belt 15 from meandering. The back-up roll 22 is arranged in the secondary transfer unit 20 so as to be opposed to a secondary transfer roll 21. The cleaning back-up roll 34 is arranged in a cleaning unit that is provided to scrape the toner remaining on the intermediate transferring belt 15. Specifically, the cleaning back-up roll 34 is provided so as to be opposed to a belt cleaner 35.

Each of the primary transfer rolls 16 is opposed to the corresponding one of the photoconductor drums 11, and is arranged at the inner side of the intermediate transferring belt 15 that extends in a substantially linear fashion. A predetermined primary transfer voltage (or current) is applied to each of the primary transfer rolls 16. Each of the toner images on the respective photoconductor drums 11 is thus attracted electrostatically to the intermediate transferring belt 15 one after another to form, on the intermediate transferring belt 15, toner images of the respective colors, which images are superimposed with each other.

The secondary transfer unit 20 includes the secondary transfer roll 21 and the back-up roll 22. The secondary transfer roll 21 is arranged so as to be in contact with the surface side of the intermediate transferring belt 15 on which surface the toner image is held. The back-up roll 22 is opposed to the secondary transfer roll 21 while the intermediate transferring belt 15 is sandwiched between the back-up roll 22 and the secondary transfer roll 21, and is arranged so as to be in contact with the surface side of the intermediate transferring belt 15 on which surface no toner image is held. While the surface side of the back-up roll 22 is made of a tube of a blend rubber of NBR (nitrile butadiene rubber) and EPDM (ethylene propylene diene monomer) on which carbon is dispersed, the inside of the back-up roll 22 is made of EPDM rubber. A predetermined secondary transfer voltage (or current) is applied to a portion between the secondary transfer roll 21 and the back-up roll 22. It should be noted that an image forming device is configured by the image forming units 10, the intermediate transferring belt 15, and the secondary transfer unit 20 in the first exemplary embodiment.

On the downstream side of the secondary transfer unit 20 in the intermediate transferring belt 15, the belt cleaner 35 that cleans the intermediate transferring belt 15 after the second transfer is attached. The belt cleaner 35 is arranged so as to be opposed to the cleaning back-up roll 34 while the intermediate transferring belt 15 is sandwiched in between.

A paper-sheet transporting system of the first exemplary embodiment includes a paper-sheet storing unit 50, a pick-up roll 51, transporting rolls 52, resist rolls 53, a guide member 54 and a transporting belt 55. Paper sheets P as recording mediums are stored in the paper-sheet storing unit 50. The pick-up roll 51 picks up one of the paper sheets P piled in this paper-sheet storing unit 50 at a predetermined timing, and then transports the picked-up paper sheet P to a transporting route 56. The transporting rolls 52 serve as examples of transporting devices and transport the paper sheet P that has been sent out by the pick-up roll 51. The resist rolls 53 serve as examples of adjusting devices rotates, stop the rotation for adjusting the timing for a while, and then restart the rotation, and further supply the paper sheet P while adjusting the position of the paper sheet P on the transporting route. The guide member 54 guides the paper sheet P transported by the resist rolls 53 to the secondary transfer unit 20. The transporting belt 55 transports the paper sheet P that has been passed through the secondary transfer unit 20 to the fixing unit 60.

In the first exemplary embodiment, a reversing-and-transporting mechanism 70 that makes the paper sheet P reversed after fixing an image on one side of the paper sheet P by the fixing unit 60, and that makes the paper sheet P returned to the secondary transfer unit 20 is provided. The reversing-and-transporting mechanism 70 is used when the image forming apparatus is in the both-side printing mode where images are formed on both sides of the paper sheet P. The reversing-and-transporting mechanism 70 is provided with a branching route 71 that diverges from a discharging route 57 from the fixing unit 60 in the downward direction, a reversing route 72 that extends from the branching route 71 toward the right lateral direction of the branching route 71, and a returning route 73 that extends from the reversing route 72 and that is returned to the transporting route 56 from the paper-sheet storing unit 50 so that these routes are communicatively connected one after another. An appropriate number of transporting rolls 74 are provided along these routes when necessary. A gate 75 is arranged at the outlet side of the fixing unit 60 to switch the transporting directions of the paper sheet P after fixing toner images to the discharging route 57 or the branching route 71. A gate 76 is arranged at the branching point of the branching route 71 and the returning route 73 to switch the transporting direction of the paper sheet P to the direction before reversing the paper sheet P or the direction after reversing the paper sheet P. Furthermore, switch-back rolls 77 that rotate in the forward direction or the backward direction are attached on the reversing route 72.

In addition, on the transporting route 56, a paper-sheet deburring unit 80 is arranged on the upstream side of the resist rolls 53 in the paper sheet transporting direction. The paper-sheet deburring unit 80 corrects burrs that are formed in the edge portions located in parallel with the transporting direction of the paper sheet P (side-edge portions). It should be note that the paper-sheet deburring unit 80 of the first exemplary embodiment serves as an example of a pressure applying device or a deburring device.

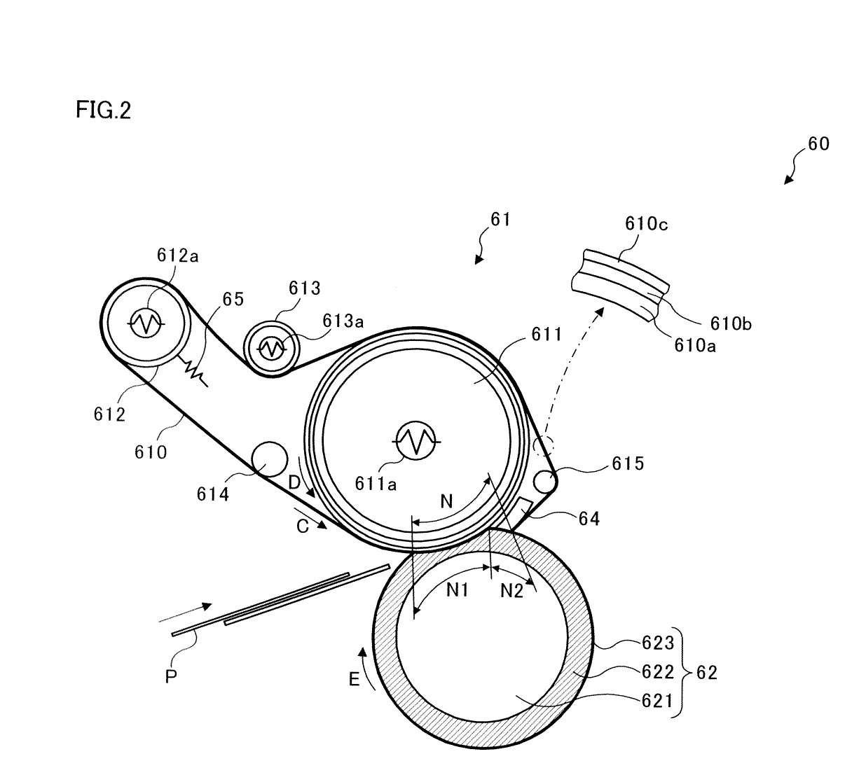

Subsequently, detailed descriptions will be given of the fixing unit 60 that serves as an example of a fixing device. FIG. 2 shows general structure of the fixing unit 60. The main portion of the fixing unit 60 is configured by a fixing belt module 61 and a pressing roll 62.

The fixing belt module 61 in the main portion of the fixing unit 60 includes an endless fixing belt 610, a fixing roll 611 that hangs the fixing belt 610, a tension roll 612 that adjusts the tension of the fixing belt 610, an external heating roll 613 that is arranged so as to be in contact with the external surface of the fixing belt 610, a belt-correction roll 614 that is provided to correct the position of the fixing belt 610, and an idler roll 615 that is provided so as to be in contact with the internal surface of the fixing belt 610. Detail descriptions of these members will be given below.

The fixing belt 610 is flexible and rotates in a direction as indicated by an arrow C in FIG. 2. The fixing belt 610 has a three-layer structure including a base layer 610a made of, for example, a polyimide; a rubber layer 610b made of, for example, a silicon rubber and piled on the top surface side of the base layer 610a, and a top surface layer 610c made of a fluorine resin and formed to cover the rubber layer 610b. Specifically, in the first exemplary embodiment, as fluorine resin for the top surface layer 610c, tetrafluoroethylene-perfluoroalkylvinylether copolymer resin (PFA) is used. As other examples of a constituent material for the top surface layer 610c, polytetrafluoroethylene (PTFE) resin, fluorinated ethylene-propylene copolymer (FEP) resin, ethylene-tetrafluoroethylene copolymer (ETFE) resin and the like are exemplified.

The fixing roll 611 is attached to the inner side of the fixing belt 610. Two separated sections of the fixing roll 611 are brought into contact with the inner surface of the fixing belt 610. Though not illustrated in the figure, a driving source such as a motor and the like drives the fixing roll 611, the fixing roll 611 is thus rotated in a direction as indicated by an arrow D in FIG. 2. Further, the fixing roll 611 is formed to be a cylindrical shape, and the two end portions thereof are supported by a supporting chassis (not shown in the figure) with bearings or the like. The fixing roll 611 is provided with a built-in heater 611a. A nip portion N, where the fixing belt 610 and the pressing roll 62 are brought into contact with each other, is formed in one of the two contact regions of the fixing belt 610 and the fixing roll 611.

The tension roll 612 is attached to a position located at the inner side of the fixing belt 610, which is similar to the attachment state of the fixing roll 611. The tension roll 612 is brought into contact with the inner surface of the fixing belt 610. The tension roll 612 is provided with a built-in heater 612a. To the tension roll 612, a spring 65 is provided, and gives a predetermined tensile force to the fixing belt 610 by pressing the fixing belt 610 through the tension roll 612.

The external heating roll 613 is attached to a position located at the outer side of the fixing belt 610. The external heating roll 613 is brought into contact with the outer surface of the fixing belt 610 on the upstream side of a contact portion between the tension roll 612 and the fixing belt 610 and on the downstream side of a contact portion between the fixing roll 611 and the fixing belt 610 in the rotating direction of the fixing belt 610. In addition, the external heating roll 613 is provided with a built-in heater 613a.

The belt-correction roll 614 is installed at a position attached to the inner side of the fixing belt 610. The belt-correction roll 614 is brought into contact with the inner surface of the fixing belt 610 on the downstream side of the contact point between the tension roll 612 and the fixing belt 610 and on the upstream side of the contact point between the fixing roll 611 and the fixing belt 610 in the rotating direction of the fixing belt 610. The belt-correction roll 614 corrects a position of the fixing belt by changing the axial direction thereof.

The idler roll 615 is attached to a position located at the inner side of the fixing belt 610. The idler roll 615 is brought into contact with the inner surface of the fixing belt 610 on the downstream side of the nip portion N and the upstream side of the region where the fixing belt 610 is brought into contact with the fixing roll 611 again in the rotating direction of the fixing belt 610.

The fixing belt module 61 is provided with a removal pad 64. The removal pad 64 is attached to a position located at the inner side of the fixing belt 610. The removal pad 64 is brought into contact with the inner surface of the fixing belt 610 on the downstream side of the nip portion N and on the upstream side of the contact portion between the idler roll 615 and the fixing belt 610 in the rotating direction of the fixing belt 610. The removal pad 64 presses the fixing belt 610 from the inner-surface side thereof to the pressing roll 62.

The removal pad 64 is made of stainless steel that is processed into a thin plate, and has a substantially arc-shaped cross section. The removal pad 64 is arranged at a position near and on the downstream side of the region where the pressing roll 62 is pressed against and brought into contact with the fixing roll 611 with the fixing belt 610 being sandwiched in between. This region is referred to as a “roll-nip portion N1” from now on. The removal pad 64 is arranged at a position at the inner circumferential side of the fixing belt 610 to press evenly the pressing roll 62, with the fixing belt 610 sandwiched in between, along a region with a predetermined width, and with a predetermined load. As a result, a “removal-pad nip portion N2” is formed, within the nip portion N, so as to be contiguous to the roll-nip portion N1.

The pressing roll 62, on the other hand, is arranged to form the nip portion N by being in contact with the fixing belt 610. The pressing roll 62 rotates in a direction as indicated by the arrow E when the fixing belt 610 rotates. The pressing roll 62 is provided with a columnar roll 621, a rubber layer 622 formed on the outer circumferential surface of the columnar roll 621, and a resin layer 623 formed on the rubber layer 622. The columnar roll 621 is made of aluminum or the like, the rubber layer 622 is made of a rubber medium, such as a silicone rubber and a fluorine-containing rubber, and the resin layer 623 is made of a resin, such as a fluorine resin (for example, PFA).

Both the fixing belt 610 and the pressing roll 62 of the first exemplary embodiment are each provided with a layer of a fluorine resin at the outer circumferential surface, so that the fixing unit 60 needs no oil that would be used in the removing of the paper sheet P in an ordinary fixing unit. Accordingly, the fixing unit 60 is not provided with any mechanism to apply silicone oil or the like onto the surface of the fixing belt 610 and onto the surface of the pressing roll 62.

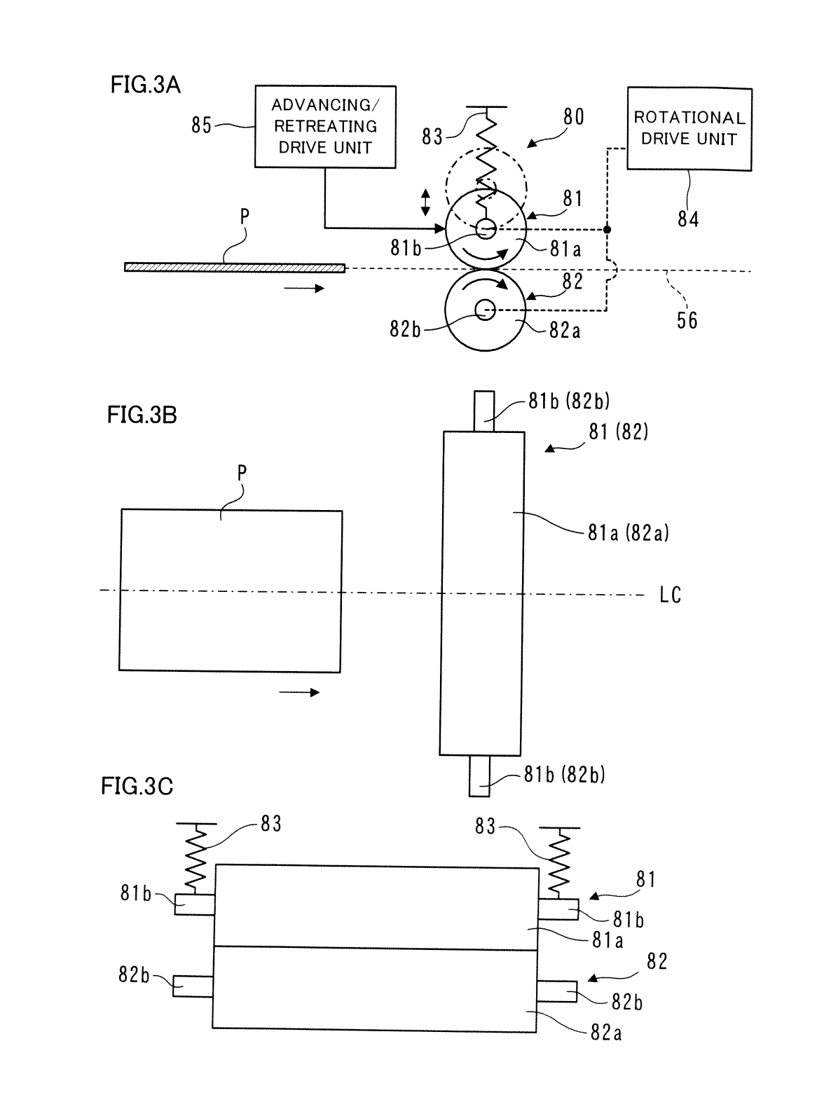

Subsequently, detailed descriptions will be given of the paper-sheet deburring unit 80 of the first exemplary embodiment. FIG. 3A shows the paper-sheet deburring unit 80 viewed from a direction that crosses the transporting direction of the paper sheet P. FIG. 3B shows the paper-sheet deburring unit 80 viewed from the top thereof, and FIG. 3C shows the paper-sheet deburring unit 80 viewed from the downstream side in the transporting direction of the paper sheet P.

The paper-sheet deburring unit 80 includes a first roll 81, a second roll 82, two coil springs 83, a rotational drive unit 84 and an advancing/retreating drive unit 85.

The first roll 81 is provided at a position located at the upper side of the transporting route 56. The first roll 81 includes a first-roll body 81a and a first shaft 81b. The columnar first-roll body 81a extends in a direction that crosses the transporting route 56. The first shaft 81b sticks out from the two end portions in the longitudinal direction of the first-roll body 81a. The first shaft 81b is supported by a supporting chassis that is not illustrated here with bearings and the like nipped in between.

The second roll 82 is provided at a position located at the lower side of the transporting route 56 so as to be opposed to the first roll 81. The second roll 82 includes a second-roll body 82a and a second shaft 82b. The columnar second-roll body 82a extends in a direction that crosses the transporting route 56. The second shaft 82b sticks out from the two end portions in the longitudinal direction of the second-roll body 82a. The second shaft 82b is supported by a supporting chassis that is not illustrated here with bearings and the like nipped in between.

Both the first roll 81 and the second roll 82 are made of a metal material such as aluminum and a stainless steel. The diameter of the first-roll body 81a and that of the second-roll body 82a are selected from a range between 8 mm to 20 mm, inclusive. The first-roll body 81a and that of the second-roll body 82a are 350 mm long in the axial direction thereof, respectively. Each of these roll bodies 81a and 82a is slightly longer than the width of the largest one of the paper sheets P that is used in this image forming apparatus. Specifically, the length 350 mm is slightly larger than the width of 297 mm of the shorter side of an A3 paper sheet.

Incidentally, in the first exemplary embodiment, when the first roll 81 is assumed to serve as an example of a counter member, the second roll 82 is considered as a transporting member. In contrast, when the second roll 82 is assumed to serve as an example of a counter member, the first roll 81 is considered as a transporting member.

Each of the two coil springs 83 has one end attached to a chassis (not illustrated) and the other end attached to the corresponding one of the end portions of the first shaft 81b of the first roll 81. The two coil springs 83 give a downward force in FIGS. 3A and 3C to the first shaft 81b of the first roll 81. Thus the first roll 81 and the second roll 82 are in contact with each other along the axial direction thereof while no paper sheet P is passing in between.

The rotational drive unit 84 drives the first roll 81 and the second roll 82 in directions as indicated by the respective arrows shown in the drawing which is the direction for transporting the paper sheet P.

The advancing/retreating drive unit 85, which serves as an example of a changing device, moves the first roll 81 towards, or away from, the second roll 82. The first roll 81 driven by the advancing/retreating drive unit 85 moves between a position where the first roll 81 is to be brought into contact with the second roll 82 (as shown by a solid line in FIG. 3A) and a position where the first roll 81 is separated from the second roll 82 (as shown by a dashed-dotted line in FIG. 3A).

In this image forming apparatus, the paper sheet P is transported so that the center position in a direction crossing the transporting direction of the paper sheet P (hereinafter simply referred to as the “center position”) is located on the same line irrespective of the size of the paper sheet P. For example, in the paper-sheet deburring unit 80 shown in FIG. 3B, the paper sheet P of any size is transported with its center position aligned on a central reference line LC that passes at the center portions of the first roll 81 and the second roll 82 in the axial direction thereof.

Subsequently, descriptions will be given of a basic image-formation process in the image forming apparatus of the first exemplary embodiment. Firstly, image data is outputted from an image-reading apparatus (not illustrated), a computer (not illustrated) or the like, and then is inputted into the image forming apparatus shown in FIG. 1. In the image forming apparatus, various predetermined image processings are carried out on the data by an image processing apparatus (not illustrated), and then image formation is executed using the image forming units 10 and the like. The image processings carried out by the image processing apparatus on the received reflectance data include various predetermined image editings such as shading correction, displacement correction, color-value/color-space conversion, gamma correction, border erasing, color editing, editing by moving and the like. The image data having been subjected to the image processings is converted into gradation data of four color materials—yellow (Y), magenta (M), cyan (C) and black (K). The data thus converted is then outputted to the laser exposure unit 13.

The laser exposure unit 13 irradiates the exposure beam Bm outputted, for example, from a semi-conductor laser apparatus onto the photoconductor drums 11 of the image forming units 10Y, 10M, 10C and 10K in accordance with the received color-material gradation data. The surface of each of the photoconductor drums 11 of the image forming units 10Y, 10M, 10C and 10K is electrically charged by the charging unit 12, and then scanned and exposed by the laser exposure unit 13 to form an electrostatic latent image. The electrostatic latent image thus formed is then developed as toner images of yellow (Y), magenta (M), cyan (C) and black (K) by the respective developing units 14 of the image forming units 10Y, 10M, 10C and 10K.

The toner images formed respectively on the photoconductor drums 11 of the image forming units 10Y, 10M, 10C and 10K are transferred onto the intermediate transferring belt 15 at respective primary transfer units. Each of the primary transfer unit is the place where the photoconductor drum 11 is brought into contact with the intermediate transferring belt 15. The images that have been thus primarily transferred and not yet fixed are then transported to the secondary transfer unit 20 as the intermediate transferring belt 15 rotates.

Incidentally, in the paper-sheet transporting system, the pick-up roll 51 rotates in accordance with the timing for image formation, and thus the paper sheet P of a predetermined size stored in the paper-sheet storing unit 50 is supplied. The paper sheet P thus supplied by the pick-up roll 51 is then transported along the transporting route 56 by the transporting rolls 52. Meanwhile, the paper sheet P is deburred by the paper-sheet deburring unit 80. The paper sheet P having been passed through the paper-sheet deburring unit 80 is then stopped once by the resist rolls 53 before reaching the secondary transfer unit 20. The resist rolls 53 resume their rotation in accordance with the timing of the movement of the intermediate transferring belt 15 on which the toner images are held. The alignment of the position of the paper sheet P along the transporting route 56 is achieved in this way. The paper sheet P sent out from the resist rolls 53 reaches the secondary transfer unit 20 via the guide member 54.

In the secondary transfer unit 20, the secondary transfer roll 21 presses the back-up roll 22 with the intermediate transferring belt 15 being sandwiched in between. The paper sheet P that is transported by having adjusted the timing thereof is sandwiched by and between the intermediate transferring belt 15 and the secondary transfer roll 21. The toner images that have not yet been fixed are transferred electrostatically onto the paper sheet P at a secondary transfer position that is formed by the secondary transfer roll 21 and the back-up roll 22.

Thereafter the transporting belt 55 transports the paper sheet P to which the toner images having been electrostatically transferred. While the paper sheet P is transported, the paper sheet P is in a state of being removed from the intermediate transferring belt 15. The toner images have not been fixed yet when the paper sheet P reaches the fixing unit 60, but the images are fixed in the fixing unit 60 by heat and pressure. The paper sheet P that has been passed through the fixing unit 60 with an image having been formed on one side thereof is directed towards the discharging route 57 by the gate 75, and is then discharged out of the image forming apparatus. After the images are transferred to the paper sheet P, the toner remaining on the intermediate transferring belt 15 is further transported by the rotational movement of the intermediate transferring belt 15 until the cleaning back-up roll 34 and the belt cleaner 35 remove the toner from the intermediate transferring belt 15.

Alternatively, in a case where images are formed on both sides of the paper sheet P, the gate 75 makes the leading edge of the paper sheet P that has been passed through the fixing unit 60 enter the branching route 71. After the paper sheet P is transported through the branching route 71, the paper sheet P is made to enter the reversing route 72 by the gate 76. While the paper sheet P is on the reversing route 72, the switch-back rolls 77 transport the paper sheet P towards the other side of the gate 76 once. Then, the paper sheet P is stopped once immediately after the rear edge of the paper sheet P comes out of the gate 76. Thereafter, at a predetermined timing, the switch-back rolls 77 rotate in the reverse direction, and thus transport the paper sheet P in the opposite direction. At this time, the paper sheet P is made to enter the returning route 73 by the gate 76. The paper sheet P having passed through the returning route 73 is returned back to the transporting route 56. The paper sheet P is now upside down from the state in which the paper sheet P is originally on the transporting route 56. The paper sheet P is deburred again by the paper-sheet deburring unit 80. Then, by the above-mentioned processes, the toner images are electrostatically transferred onto the reverse side of the paper sheet P, but the transferred images are not fixed yet. Thereafter, the images are fixed by the fixing unit 60, and then the paper sheet P is discharged out of the image forming apparatus.

Now, with reference to FIG. 2, detailed descriptions are given of the fixing operation performed in the fixing unit 60.

The paper sheet P, holding the toner images (not illustrated) and being transported by the transporting belt 55 (see FIG. 1), is transported into the nip portion N. In this event, the fixing roll 611 rotates in the direction as indicated by the arrow D by the driving force from the driving source (not illustrated). The fixing belt 610 rotates, as being driven by the rotation of the fixing roll 611, in the direction as indicated by the arrow C. The pressing roll 62 rotates, as being driven by the rotation of the fixing belt 610, in the direction as indicated by the arrow E. When the images are actually fixed, a power supply unit (not illustrated) supplies electric power to the heaters 611a, 612a and 613a. The fixing roll 611, the tension roll 612 and the external heating roll 613 are thus heated up to predetermined temperatures respectively.

In the state described above, the paper sheet P thus transported into the nip portion N is transported in the downstream direction by the fixing belt 610 and the pressing roll 62. The paper sheet P passes through the roll-nip portion N1 and then through the removal-pad nip portion N2. While the paper sheet P is passing through the roll-nip portion N1 and the removal-pad nip portion N2, the fixing belt 610 and the pressing roll 62 heat up and press on the paper sheet P. As a result, the toner images are fixed on the paper sheet P. The fixing belt 610 that has passed through the removal-pad nip portion N2 is then moved as following a side surface of the removal pad 64.

Accordingly, the advancing direction of the fixing belt 610 is abruptly altered as bending towards the idler roll 615. The paper sheet P having been heated and pressed in the nip portion N does not follow the abrupt alteration of the advancing direction of the fixing belt 610 when the paper sheet P comes out of the nip portion N. As a result, the paper sheet P is removed from the fixing belt 610 by the “stiffness” of its own. The paper sheet P thus removed from the fixing belt 610 is then discharged from the image forming apparatus.

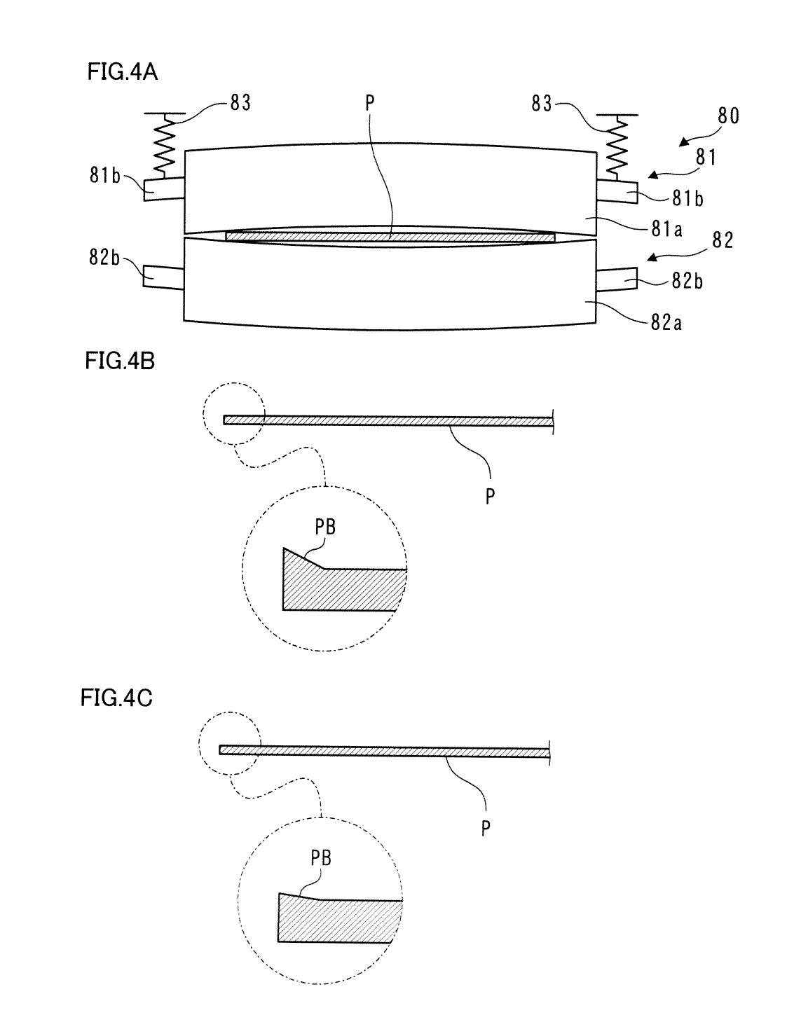

Subsequently, with reference to FIG. 4, descriptions will be given of the paper-sheet deburring operation carried out in the paper-sheet deburring unit 80. Precisely, what will be described is the deburring operation for the burrs that exist at the two edge portions (the two side-edge portions) of the paper sheet P in the direction parallel to the transporting direction of the paper sheet P. FIG. 4A shows the state in which the paper sheet P passes between the first and the second rolls 81 and 82, each of which is a component part of the paper-sheet deburring unit 80. FIG. 4B shows the state of one of the side-edge portions before the paper sheet P passes through the paper-sheet deburring unit 80. FIG. 4C shows the state of one of the side-edge portions after the paper sheet P passes through the paper-sheet deburring unit 80. It should be noted that the first roll 81 is placed at a position separated away from the second roll 82 (the position is shown by the dotted-dashed line in FIG. 3) before the image-formation operation starts.

When the image-formation operation starts, the advancing/retreating drive unit 85 moves the first roll 81 downwards in the drawing, and stops the first roll 81 at a position where the first-roll body 81a is to be brought into contact with the second-roll body 82a (FIG. 4A shows the position). In addition, the coil springs 83 press the first roll 81 against the second roll 82 with a predetermined force. Subsequently, the rotational drive unit 84 drives to rotate the first roll 81 with the first shaft 81b and the second roll 82 with the second shaft 82b, respectively. Consequently, the first roll 81 and the second roll 82 rotate in the same direction at the contact position between the first roll 81 and the second roll 82. It should be noted that, when the image-formation operation is finished, the rotational drive unit 84 stops the driving of the first roll 81 and the second roll 82. Meanwhile, the advancing/retreating drive unit 85 moves the first roll 81 upwards in the figure, and stops the first roll 81 at a position such that the first-roll body 81a is separated away from the second-roll body 82a after the image-formation operation is finished.

The paper sheet P that has been sent out from the paper-sheet storing unit 50 is then transported into the paper-sheet deburring unit 80. There, as FIG. 4A shows, the paper sheet P is sandwiched by and between the first-roll body 81a of the first roll 81 and the second-roll body 82a of the second roll 82. Here, the paper sheet P has a predetermined thickness (for example, a heavy paper has an approximately 200-μm thickness), so that the insertion of the paper sheet P forms a predetermined gap between the first-roll body 81a and the second-roll body 82a. When the gap is formed, the first roll 81 attempts to move to a side such that the first roll 81 is separated away from the second roll 82 (i.e., upwards in the drawing). Meanwhile, the coil springs 83 press the first roll 81 to the side of the second roll 82. For this reason, the first roll 81 is bent in the axial direction thereof. Specifically, the two end portions of the first roll 81 in the axial direction thereof attempt to approach the second roll 82 while the central area of the first roll 81 in the axial direction thereof attempts to move away from the second roll 82. Concurrently, the second roll 82 is also bent in the axial direction thereof. Specifically, the two end portions of the second roll 82 in the axial direction thereof attempt to approach the first roll 81 while the central area of the second roll 82 in the axial direction thereof attempts to move away from the first roll 81. It should be noted that the two end portions of the first-roll body 81a in the axial direction are not in contact with the corresponding two end portions of the second-roll body 82a in the axial direction thereof.

As a consequence, the two edge portions of the paper sheet P in a direction parallel to the transporting direction thereof, that is, the two side-edge portions of the paper sheet P, are pressed on, by the first-roll body 81a and the second-roll body 82a, with a predetermined pressure that is not high enough to deform the paper sheet P (not higher than 100 MPa, and for example, approximately 4 MPa).

Here, as FIG. 4B shows, the paper sheet P supplied from the paper-sheet storing unit 50 sometimes has burrs PB at the side-edge portions thereof. The burrs PB are formed when the paper sheet P is manufactured by cutting the base paper.

The paper sheet P with the above-mentioned features is subjected to the following processing in the paper-sheet deburring unit 80. The burrs PB of the paper sheet P are sandwiched by the first-roll body 81a and the second-roll body 82a, and are subjected to a predetermined pressure. Consequently, the burrs PB are deformed by being pressed on. The resultant paper sheet P that is discharged out of the paper-sheet deburring unit 80 has burrs PB with such a reduced height as shown in FIG. 4C.

In this image-formation apparatus, PFA is used as the material for the top surface layer 610c of the fixing belt 610 used in the fixing unit 60, that is, the contact portion of the fixing unit 60 with the paper sheet P on which the toner is held. The PFA is gradually worn away by being in contact with the paper sheet P. When the burrs PB of the paper sheet P are large, the contact portions with the burrs PB tend to become rough. Such a phenomenon is especially noticeable in the case of a fluorine resin, such as PFA (tetrafluoroethylene-Perfluoroalkylvinyl ether copolymer). Incidentally, the paper sheets P ordinarily used in an image forming apparatus are of a standardized size. Image formation by use of the paper sheets P of the same size in the same layout brings the same portions of the fixing belt 610 into contact with the burrs PB of the paper sheets P. Then, in the contact portions of the top surface layer 610c with the burrs PB, rough regions are formed linearly along the paper-sheet transporting direction. When the toner images on the paper sheet P are fixed, such rough regions may sometimes form streaks where the toner images are fixed unevenly. As a countermeasure to this phenomenon, the paper-sheet deburring unit 80 in the first exemplary embodiment reduces, in advance, the height of the burrs PB of the paper sheet P. In addition, in this image forming apparatus, the paper sheet P that has passed through the reversing-and-transporting mechanism 70 is made to pass through the paper-sheet deburring unit 80 again. In this way, even when images are formed in the duplex-printing mode, the height of the burrs PB in the side-edge portions of the paper sheet P is reduced on both sides of the paper sheet P.

### Second Exemplary Embodiment

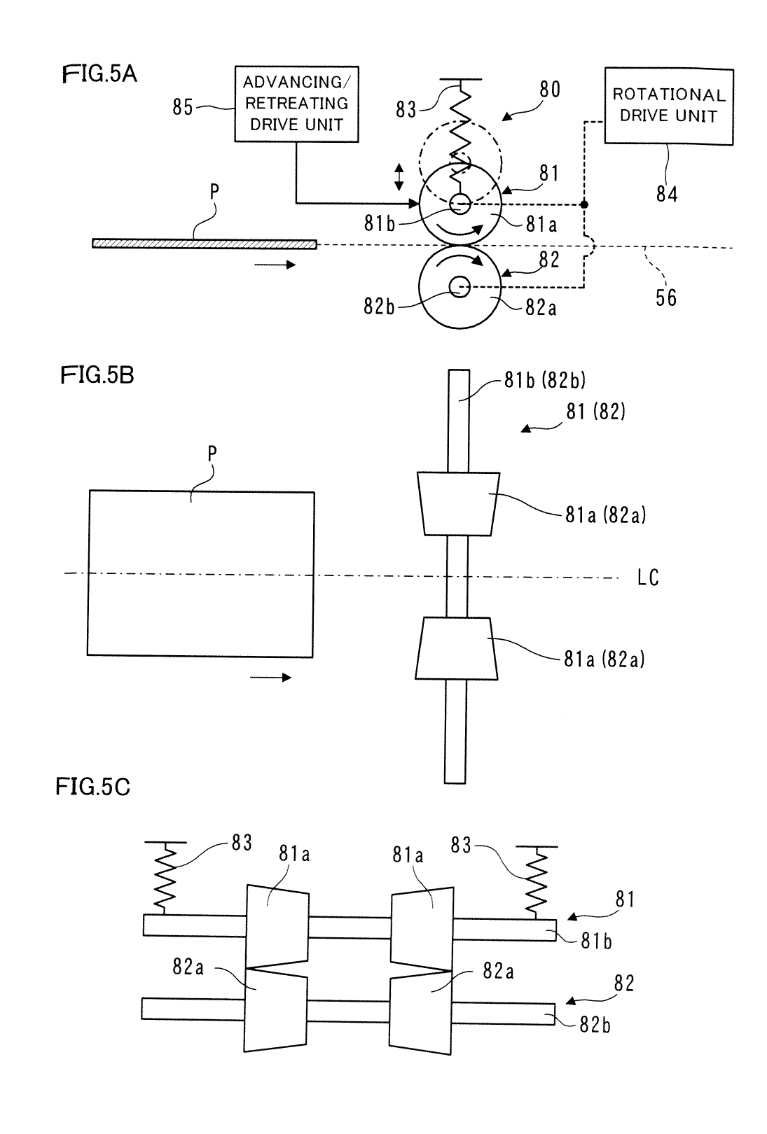

FIG. 5A shows a paper-sheet deburring unit 80 of the second exemplary embodiment viewed from a direction that crosses the transporting direction of a paper sheet P. FIG. 5B shows the paper-sheet deburring unit 80 viewed from the top thereof, and FIG. 5C shows the paper-sheet deburring unit 80 viewed from the downstream side in the transporting direction of the paper sheet P. It should be noted that, when component parts and the like of the second exemplary embodiment are similar to those of the first exemplary embodiment, the same reference numerals are given to those component parts, and no detailed descriptions thereof will be given.

A first roll 81 has two first-roll bodies 81a. Each of the first-roll bodies 81a has a tapered outer circumferential surface with a 10 mm diameter on its larger-diameter side and a 9.9 mm diameter on its smaller-diameter side. The two first-roll bodies 81a are attached onto a first shaft 81b with their respective smaller-diameter sides facing each other.

A second roll 82, on the other hand, also has two second-roll bodies 82a. Each of the second-roll bodies 82a also has a tapered outer circumferential surface with a 10 mm diameter on its larger-diameter side and a 9.9 mm diameter on its smaller-diameter side. The two second-roll bodies 82a are attached onto a second shaft 82b with their respective smaller-diameter sides facing each other. In addition, the two second-roll bodies 82a are attached there so as to respectively face the two first-roll bodies 81a that are included in the first roll 81.

Here, when the first roll 81 is assumed to serve as an example of a counter member, the second roll 82 is considered as a transporting member. In this case, the two first-roll bodies 81a serve as examples of a first counter member and a second counter member respectively. In contrast, when the second roll 82 is assumed to serve as an example of a counter member, the first roll 81 is considered as an example of a transporting member. In this case, the two second-roll bodies 82a serve as examples of a first counter member and a second counter member respectively.

Incidentally, as in the case of the first exemplary embodiment, the first roll 81 and the second roll 82 are made of a metal material such as aluminum and a stainless steel.

It should be noted that each of the first-roll bodies 81a and the second-roll bodies 82a is attached at a position where one of the side-edge portions of the paper sheet P passes.

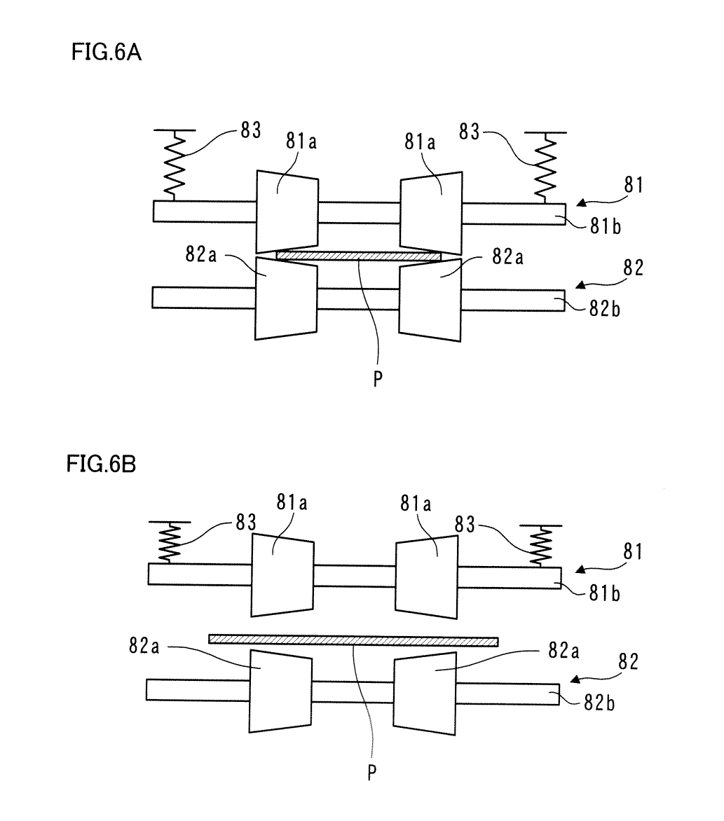

FIGS. 6A and 6B are diagrams to describe the paper-sheet deburring operation in the paper-sheet deburring unit 80. As shown in FIG. 6A, the paper sheet P that has been transported into the paper-sheet deburring unit 80 is sandwiched by and between each of the two first-roll bodies 81a and the corresponding one of the two second-roll bodies 82a. The insertion of the paper sheet P forms a predetermined gap between each of the first-roll bodies 81a and the corresponding one of the second-roll bodies 82a. When the gaps are formed, the first roll 81 moves to a side such that the first roll 81 is separated away from the second roll 82 (i.e., upwards in the figure). Meanwhile, the two coil springs 83 press the first roll 81 to the side of the second roll 82.

In the second exemplary embodiment, each of the first-roll bodies 81a and the second-roll bodies 82a has an outer circumferential surface that is tapered with respect to the plane surface of the paper sheet P. The two side-edge portions of the paper sheet Pare pressed on, by the first-roll bodies 81a and the second-roll bodies 82a, with a predetermined pressure (for example, approximately 4 MPa). It should be noted that each of the first-roll bodies 81a is not in contact with the corresponding one of the second-roll bodies 82a.

As a consequence, also in the second exemplary embodiment, the height of the burrs PB (see FIG. 4) that exist on the side-edge portions of the paper sheet P is reduced by making the paper sheet P pass through the paper-sheet deburring unit 80.

Now, suppose a case of transporting a paper sheet P with a larger size than the size of the paper sheet P to be deburred with the paper-sheet deburring unit 80. In such a case, as FIG. 6B shows, the advancing/retreating drive unit 85 moves the first roll 81 upwards in the figure, and stops the first roll 81 at a position such that each of the first-roll bodies 81a is separated away from the corresponding one of the second-roll bodies 82a by a predetermined distance (for example, several millimeters). Accordingly, no pressing marks, which might possibly be left otherwise by the first roll 81 and the second roll 82, are left on the paper sheet P while the paper sheet P is being transported. The paper sheet P is then outputted with no such marks left thereon. Alternatively, when it is necessary, other first rolls 81 and other second rolls 82 that are suitable for this paper sheet P of the larger size may be prepared so as to correct burrs PB in the paper sheet P.

### Third Exemplary Embodiment

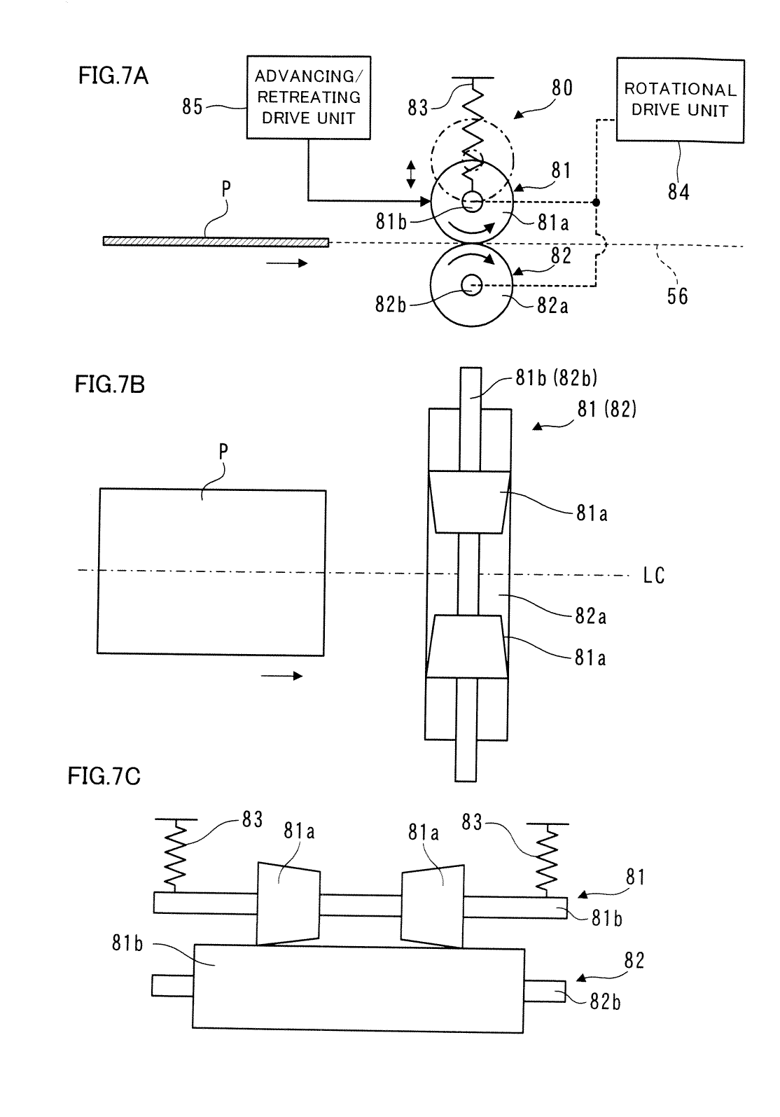

FIG. 7A shows a paper-sheet deburring unit 80 of the third exemplary embodiment viewed from a direction that crosses the transporting direction of a paper sheet P. FIG. 7B shows the paper-sheet deburring unit 80 viewed from the top thereof, and FIG. 7C shows the paper-sheet deburring unit 80 viewed from the downstream side in the transporting direction of the paper sheet P. It should be noted that, when component parts and the like of the third exemplary embodiment are similar to those of the above-described exemplary embodiment, the same reference numerals are given to those component parts, and no detailed descriptions thereof will be given.

In the third exemplary embodiment, as in the case of the second exemplary embodiment, a first roll 81 includes two first-roll bodies 81a each with a tapered outer circumferential surface, and also includes a first shaft 81b that penetrates and supports the two first-roll bodies 81a. Also as in the case of the second exemplary embodiment, each of the two first-roll bodies 81a is attached at a position where one of the two edge portions of the paper sheet P in the direction parallel to the transporting direction thereof passes. Meanwhile, a second roll 82 that is similar to that of the first exemplary embodiment is provided. The second roll 82 in the third exemplary embodiment includes a cylindrical second-roll body 82a and a second shaft 82b. Incidentally, as in the case of the first and the second exemplary embodiments, the first roll 81 and the second roll 82 are made of a metal material such as aluminum and a stainless steel.

It should be noted that, in the third exemplary embodiment, when the first roll 81 is assumed to serve as an example of a counter member, the second roll 82 is considered as a transporting member. In contrast, when the second roll 82 is assumed to serve as an example of a counter member, the first roll 81 is considered as a transporting member. When the first roll 81 is considered as a counter member, the two first-roll bodies 81a serve as examples of a first counter member and a second counter member, respectively.

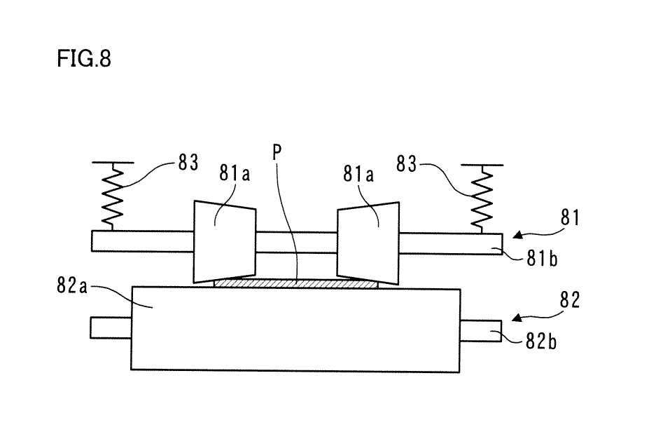

FIG. 8 is a diagram to describe the paper-sheet deburring operation in the paper-sheet deburring unit 80. The paper sheet P that has been transported into the paper-sheet deburring unit 80 is sandwiched by and between each of the two first-roll bodies 81a and the second-roll body 82a. The insertion of the paper sheet P forms a predetermined gap between each of the first-roll bodies 81a and the second-roll body 82a. When the gaps are formed, the first roll 81 moves to a side such that the first roll 81 is separated away from the second roll 82 (i.e., upwards in the figure). Meanwhile, the two coil springs 83 press the first roll 81 to the side of the second roll 82.

In the third exemplary embodiment, each of the first-roll bodies 81a has an outer circumferential surface that is tapered with respect to the plane surface of the paper sheet P. The two side-edge portions of the paper sheet P are pressed against the second-roll body 82 by each of the first-roll bodies 81a, with a predetermined pressure (for example, approximately 4 MPa.) It should be noted that each of the first-roll bodies 81a is not in contact with the second-roll body 82a.

As a consequence, also in the third exemplary embodiment, the height of the burrs PB (see FIG. 4) that exist on the side-edge portions of the paper sheet P is reduced by making the paper sheet P pass through the paper-sheet deburring unit 80.

### Fourth Exemplary Embodiment

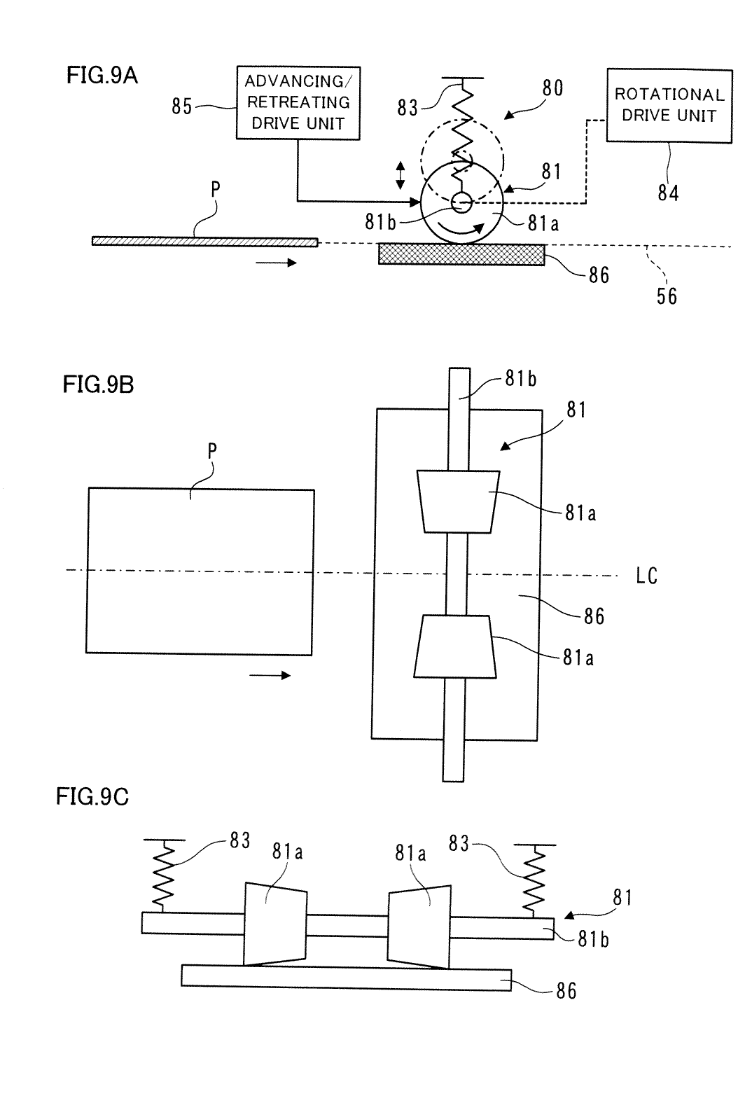

FIG. 9A shows a paper-sheet deburring unit 80 of the fourth exemplary embodiment viewed from a direction that crosses the transporting direction of a paper sheet P. FIG. 9B shows the paper-sheet deburring unit 80 viewed from the top thereof, and FIG. 9C shows the paper-sheet deburring unit 80 viewed from the downstream side in the transporting direction of the paper sheet P. It should be noted that, when component parts and the like of the fourth exemplary embodiment are similar to those of the above-described exemplary embodiment, the same reference numerals are given to those component parts, and no detailed descriptions thereof will be given.

A plate material 86 is arranged under a first roll 81, and is fixed along a transporting route 56. The plate material 86 is made of a metal, such as aluminum and a stainless steel.

Accordingly, in the fourth exemplary embodiment, the first roll 81 serves as an example of a transporting member, and the plate material 86 serves as an example of a counter member.

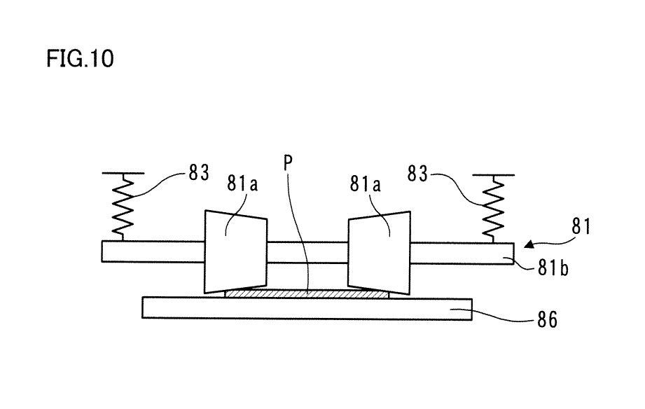

FIG. 10 is a diagram to describe the paper-sheet deburring operation in the paper-sheet deburring unit 80. The paper sheet P that has been transported into the paper-sheet deburring unit 80 is sandwiched by and between each of the two first-roll bodies 81a and the plate material 86. The insertion of the paper sheet P forms a predetermined gap between each of the first-roll bodies 81a and the plate material 86. When the gaps are formed, the first roll 81 moves to a side such that the first roll 81 is separated away from the plate material 86 (i.e., upwards in the figure). Meanwhile, the two coil springs 83 press the first roll 81 to the side of the plate material 86.

In the fourth exemplary embodiment, the first-roll bodies 81a has an outer circumferential surface that is tapered with respect to the plane surface of the paper sheet P. The two side-edge portions of the paper sheet Pare pressed against the plate material 86 by the first-roll bodies 81a, with a predetermined pressure (for example, approximately 4 MPa.) It should be noted that each of the first-roll bodies 81a is not in contact with the plate material 86.

As a consequence, also in the fourth exemplary embodiment, the height of the burrs PB (see FIG. 4) that exist on the side-edge portions of the paper sheet P is reduced by making the paper sheet P pass through the paper-sheet deburring unit 80.

### Fifth Exemplary Embodiment

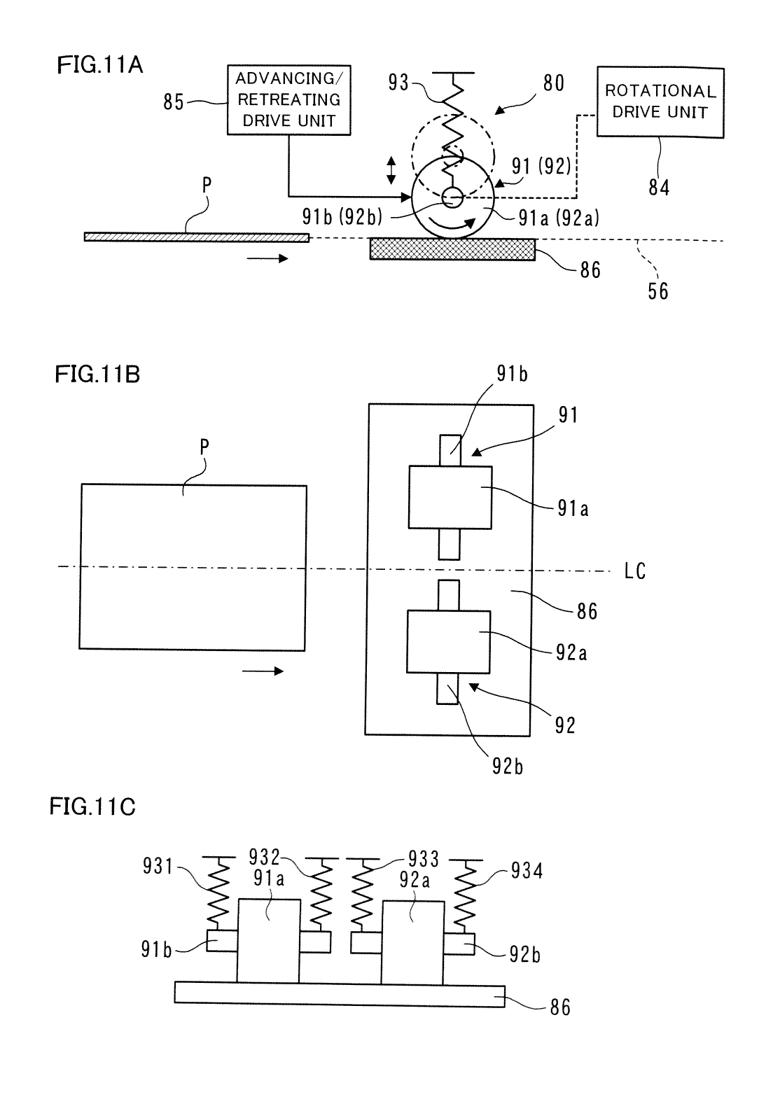

FIG. 11A shows a paper-sheet deburring unit 80 of the fifth exemplary embodiment viewed from a direction that crosses the transporting direction of a paper sheet P. FIG. 11B shows the paper-sheet deburring unit 80 viewed from the top thereof, and FIG. 11C shows the paper-sheet deburring unit 80 viewed from the downstream side in the transporting direction of the paper sheet P. It should be noted that, when component parts and the like of the fifth exemplary embodiment are similar to those of the above-described exemplary embodiment, the same reference numerals are given to those component parts, and no detailed descriptions thereof will be given.

The paper-sheet deburring unit 80 includes a first deburring roll 91, a second deburring roll 92, two coil springs 93, a rotational drive unit 84, an advancing/retreating drive unit 85 and the plate material 86.

The first deburring roll 91 is provided at a position located at the upper side of the transporting route 56. The first deburring roll 91 includes a first deburring roll body 91a which has a cylindrical shape and extends in the direction that crosses the transporting direction of the transporting route 56 and a first shaft 91b which sticks out from the two end portions in the longitudinal direction of the first deburring roll body 91a.

On the other hand, the second deburring roll 92 is provided at a position located at the upper side of the transporting route 56 so as to be brought into line with the first deburring roll 91 in the direction that crosses the transporting direction of a paper sheet P. The second deburring roll 92 includes a second deburring roll body 92a which has a cylindrical shape and extends in the direction that crosses the transporting direction of transporting route 56 and a second shaft 92b which sticks out from the two end portions in the longitudinal direction of the second deburring roll body 92a.

Each of the first deburring roll 91 and the second deburring roll and 92 is attached, as in the case, for example, of the third exemplary embodiment, to a position where one of the two side-edge portions of the paper sheet P that is being transported passes.

Each of the first deburring roll 91 and the second deburring roll 92 is made of a metal material, such as aluminum and a stainless steel. Each of the first deburring roll body 91a and the second deburring roll body 92a has a diameter selected from a range between 8 mm and 20 mm, inclusive.

It should be noted that, in the fifth exemplary embodiment, the first deburring roll 91 and the second deburring roll 92 serve as example of transporting members, and the plate material 86 serves as an example of a counter member.

Incidentally, the coil springs 93 includes a first coil spring 931, a second coil spring 932, a third coil spring 933 and a fourth coil spring 934. The first coil spring 931 and the second coil spring 932 are respectively attached to the two ends of the first shaft 91b of the first deburring roll 91. The third coil spring 933 and the fourth coil spring 934 are respectively attached to the two ends of the second shaft 92b of the second deburring roll 92. The coil springs 93 give the first deburring roll 91 and the second deburring roll 92 force directed towards the plate material 86. With this force, the first deburring roll 91 and the second deburring roll 92 are brought into contact with the plate material 86 in the axial direction thereof while no paper sheet P is passing in between.

In addition, the rotational drive unit 84, the advancing/retreating drive unit 85, and the plate material 86 are the same as those used in the exemplary embodiments described above.

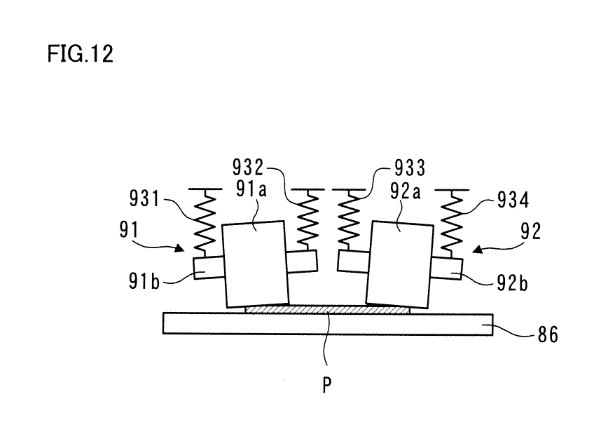

FIG. 12 is a diagram to describe the paper-sheet deburring operation carried out in the paper-sheet deburring unit 80.

The paper sheet P that has been transported into the paper-sheet deburring unit 80 is sandwiched by and between the plate material 86 and each of the first deburring roll body 91a and the second deburring roll body 92a. The insertion of the paper sheet P raises the inner-side portion of the first deburring roll 91, the inner-side portion which is brought into contact with the paper sheet P. In addition, the insertion of the paper sheet P also raises the inner-side portion of the second deburring roll 92, the inner-side portion which is brought into contact with the paper sheet P. However, the first coil spring 931 and the second coil spring 932 press the first deburring roll 91 towards the plate material 86 while the third coil spring 933 and the fourth coil spring 934 press the second deburring roll 92 towards the plate material 86.

Consequently, each of the first deburring roll 91 and the second deburring roll 92 has an inclined outer circumferential surface at the contact portion with the paper sheet P. The two side-edge portions of the paper sheet P are pressed on by the first deburring roll body 91a and the second deburring roll body 92a against the plate material 86 with a predetermined pressure (for example, approximately 4 MPa).

As a consequence, also in the fifth exemplary embodiment, the height of the burrs PB (see FIG. 4) that exist on the side-edge portions of the paper sheet P is reduced by making the paper sheet P pass through the paper-sheet deburring unit 80.

### Sixth Exemplary Embodiment

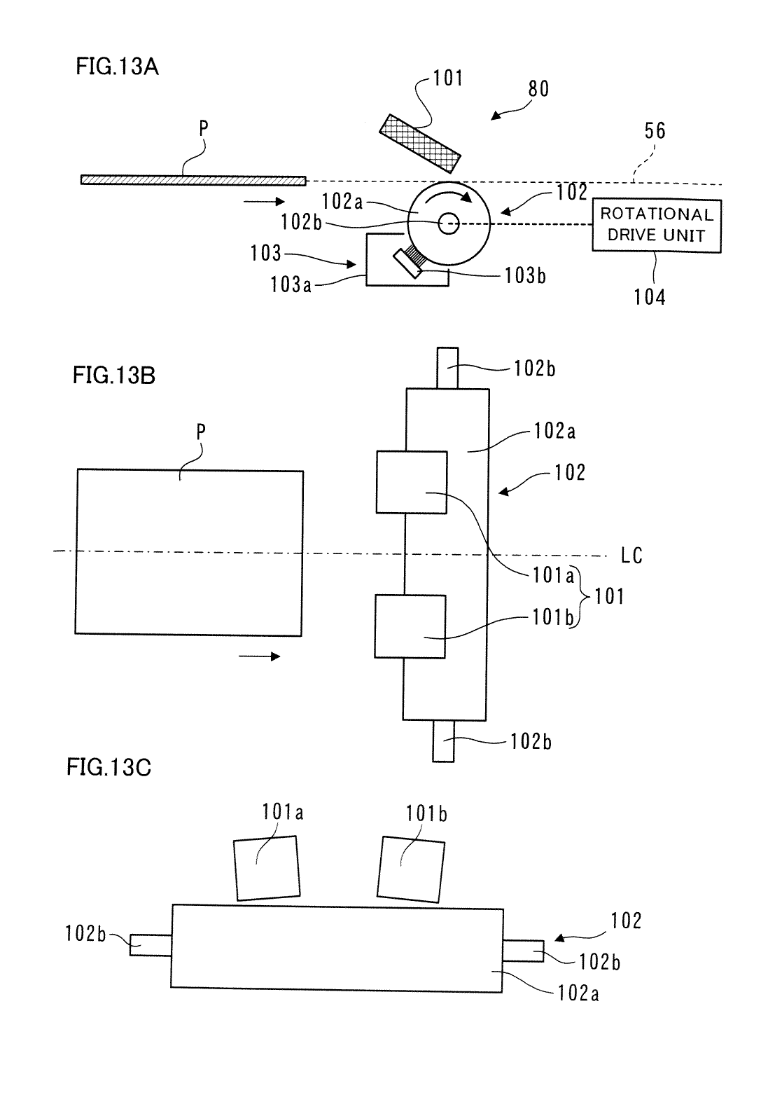

FIG. 13A shows a paper-sheet deburring unit 80 of the sixth exemplary embodiment viewed from a direction that crosses the transporting direction of a paper sheet P. FIG. 13B shows the paper-sheet deburring unit 80 viewed from the top thereof, and FIG. 13C shows the paper-sheet deburring unit 80 viewed from the downstream side in the transporting direction of the paper sheet P. It should be noted that, when component parts and the like of the sixth exemplary embodiment are similar to those of the above-described exemplary embodiment, the same reference numerals are given to those component parts, and no detailed descriptions thereof will be given.

This paper-sheet deburring unit 80 includes pressing members 101, an auxiliary roll 102, a roll cleaner 103 and a rotational drive unit 104. It should be noted that the illustration of the roll cleaner 103 is omitted in FIGS. 13B and 13C.

The pressing members 101 are provided at a position located at the upper side of a transporting route 56. The pressing members 101 are comprised by a first pressing member 101a and a second pressing member 101b, each of which is formed in a plate shape. Each of the first pressing member 101a and the second pressing member 101b is arranged so as to get gradually closer to the transporting route 56 from the upstream side to the downstream side in the transporting direction of the paper sheet P. In addition, as being evident from FIG. 13C, each of the first pressing member 101a and the second pressing member 101b is arranged so as to slant downwards to the outside when viewed from the downstream side in the transporting direction of the paper sheet P. Each of the first pressing member 101a and the second pressing member 101b is made of a plate of a metal such as aluminum and a stainless steel. The first pressing member 101a and the second pressing member 101b are fixed to a chassis (not illustrated). Each of the first pressing member 101a and the second pressing member 101b in the sixth exemplary embodiment is attached at a position where one of the side-edge portions of the paper sheet P passes, as in the case of the first-roll bodies 81a and the second-roll bodies 82a of the second exemplary embodiment.

The auxiliary roll 102 is provided at a position located at the lower side of the transporting route 56 so as to be opposed to the pressing members 101 with the side-edge portions of the paper sheet P placed in between. The auxiliary roll 102 includes an auxiliary roll body 102a and a shaft 102b. The columnar auxiliary roll body 102a extends in a direction that crosses the transporting route 56. The shaft 102b sticks out from the two end portions of the auxiliary roll body 102a in the longitudinal direction thereof. The auxiliary roll 102 is also made of a metal material such as aluminum and a stainless steel.

In the sixth exemplary embodiment, each of the first pressing member 101a and the second pressing member 101b configuring the pressing members 101 and the auxiliary roll 102 are attached with a predetermined space left in between. The space is set to be slightly larger than the standard thickness of the paper sheet P that is transported to the space.

As described above, in the sixth exemplary embodiment, the auxiliary roll 102 serves as an example of a transporting member while the pressing members 101 serve as examples of counter members.

The roll cleaner 103 that serves as an example of a removing member includes a housing 103a and a cleaning brush 103b. The housing 103a has an opening portion at a position that is opposed to the auxiliary roll 102. The cleaning brush 103b is stored in the housing 103a, and the leading end of the cleaning brush 103b is brought into contact with the auxiliary roll body 102a of the auxiliary roll 102.

The rotational drive unit 104 drives and rotates the auxiliary roll 102 in a direction as indicated by the arrow in the figure. To put it other way, the auxiliary roll 102 is rotated in a direction such as to transport the paper sheet P.

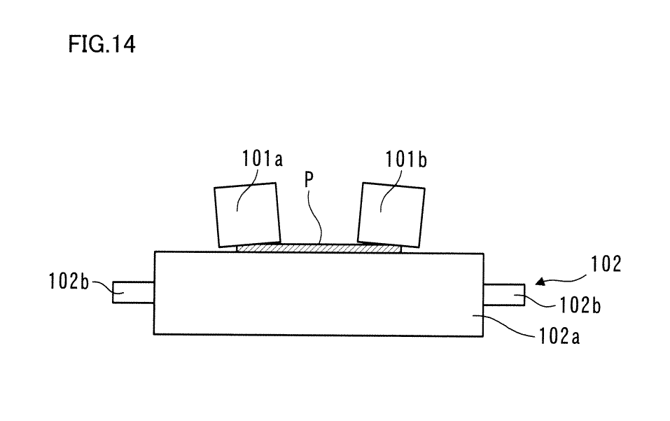

FIG. 14 is a diagram to describe the paper-sheet deburring operation in the paper-sheet deburring unit 80.

The paper sheet P that has been transported into the paper-sheet deburring unit 80 is sandwiched by and between the auxiliary roll 102 and each of the first pressing member 101a and the second pressing member 101b. The insertion of the paper sheet P brings the two side-edge portions of the paper sheet P into contact respectively with the first pressing member 101a and the second pressing member 101b. In this event, since the rotational drive unit 104 drives and rotates the auxiliary roll 102, the paper sheet P continues to be transported against the frictional force applied by the first pressing member 101a and the second pressing member The first pressing member 101a and the second pressing member 101b press on the respective side-edge portions of the passing paper sheet P with a predetermined pressure (for example, approximately 4 MPa) or, in some cases, scrape off the side-edge portions.

As a consequence, also in the sixth exemplary embodiment, the height of the burrs PB (see FIG. 4) that exist on the side-edge portions of the paper sheet P is reduced by making the paper sheet P pass through the paper-sheet deburring unit 80.

Incidentally, paper dust is produced when the burrs PB of the paper sheet P are scraped off by the first pressing member 101a and the second pressing member 101b. When the auxiliary roll 102 rotates, the paper dust that attaches to the auxiliary roll body 102a of the auxiliary roll 102 reaches the position opposed to the cleaning brush 103b so that the paper dust is then trapped by the cleaning brush 103b and is removed from the auxiliary roll body 102a. The paper dust thus removed by the cleaning brush 103b is then collected in the housing 103a.

It should be noted that the paper dust attaching to the auxiliary roll 102 is removed by the roll cleaner 103 in the sixth exemplary embodiment, but this is not the only way of removing the paper dust.

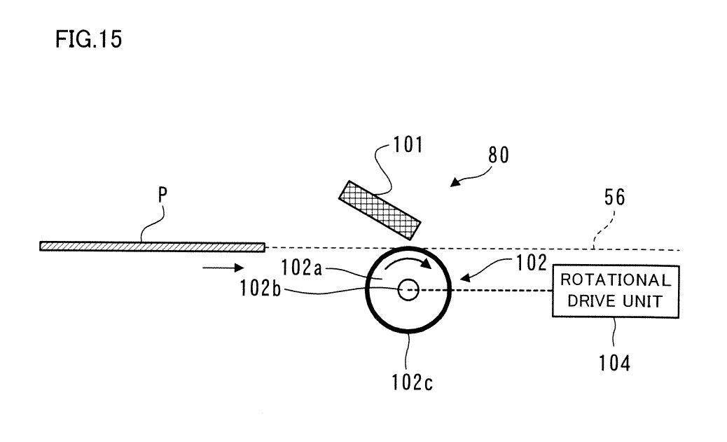

FIG. 15 shows a paper-sheet deburring unit 80 of a modified example of the sixth exemplary embodiment viewed from a direction that crosses the transporting direction of a paper sheet P.

In this modified example, no roll cleaner 103 is provided, but, instead, an adhesive layer 102c is formed on the outer circumferential surface of the auxiliary roll body 102a of the auxiliary roll 102. The adhesive layer 102c serves as an example of a removing member. Since the adhesive layer 102c is thus formed on the auxiliary roll 102, the paper dust produced in the paper-sheet deburring operation adheres to the adhesive layer 102c and is thus removed.

It should be noted that the recording medium deburring unit of the present invention in which the paper sheet is deburred is used not only in an electrophotographic image forming apparatus but may also be used in other usage (for example, an ink-jet image forming apparatus).

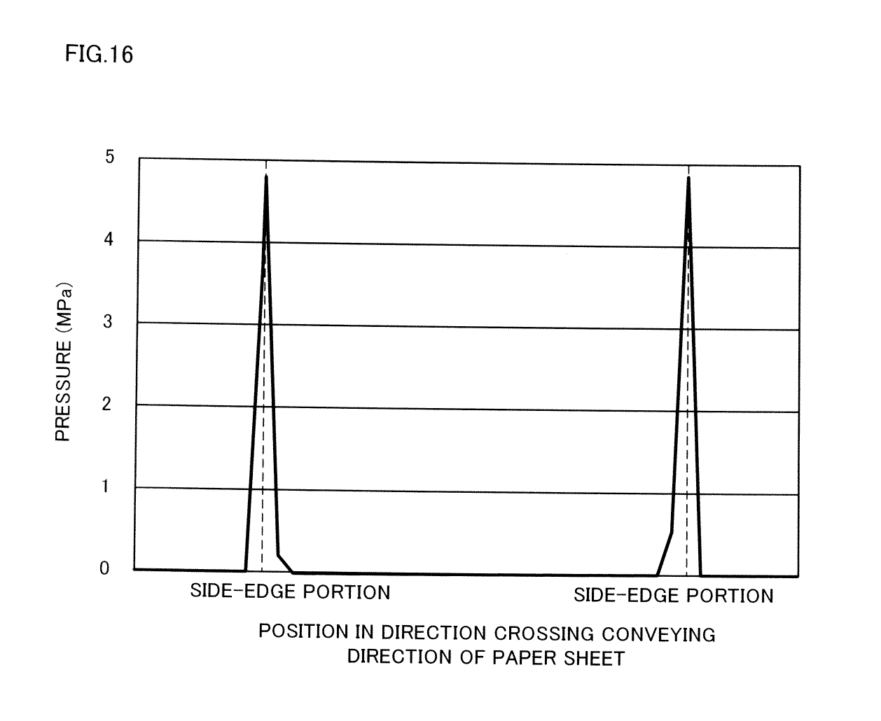

FIG. 16 is a graph showing the distribution of the pressure applied on the paper sheet P by the paper-sheet deburring unit 80 described in the first exemplary embodiment. In FIG. 16, the position in a direction crossing the transporting direction of the paper sheet P is plotted on the horizontal axis while the pressure (surface pressure) applied on the paper sheet P is plotted on the vertical axis. Precisely, the pressure was measured by a tactile sensor manufactured by Nitta Corporation, and the maximum pressure for each position is plotted on the graph. FIG. 16 clearly shows that a large pressure was applied locally on each of the two side-edge portions of the paper sheet P that passes through the paper-sheet deburring unit 80.

Similar results were obtained in the cases of the paper-sheet deburring units 80 described respectively in the second to the sixth exemplary embodiments.

Subsequently, results of examination on the pressure applied on the two side-edge portions of the paper sheet P by the paper-sheet deburring unit 80 will be given. Here, Digital Color Xpressions 98 Cover (216 g/m²) manufactured by Xerox Corporation was used as the paper sheet P. The paper sheet P is made to pass through the paper-sheet deburring unit 80 described in the first exemplary embodiment. While the paper sheet passes through, the pressure applied on the side-edge portions of the paper sheet P is varied within a range from 0.2 MPa to 10 MPa. Then, one of the paper sheet P having passed through the paper-sheet deburring unit 80 is made to pass through DocuCentre C6550I manufactured by Fuji Xerox Co., Ltd, and scratches formed on the fixing roll provided in the fixing unit are evaluated. It should be noted that a resin layer made of PFA is formed on the surface of the fixing roll. The evaluation of the scratches formed on the fixing roll is conducted by forming an image on a different paper sheet P by use of the DocuCentre C6550I and then visually observing whether or not there was a streak in the obtained image. In this case, Mirror Coat Platinum (127 g/m²) manufactured by Fuji Xerox Office Supply Co., Ltd. is used as the different paper sheet P, and is transported with the longitudinal side of the paper sheet being the leading edge. The image formed on the different paper sheet P is a solid image in process black formed by overlapping the toners of Y, M, and C each with 1001 concentration. The fixing mode in DocuCentre C6550I was set at “Heavy Paper 2.” It should be noted that in the experimental test, the fixing roll is exchanged every time one of the paper sheets P is made to pass through.

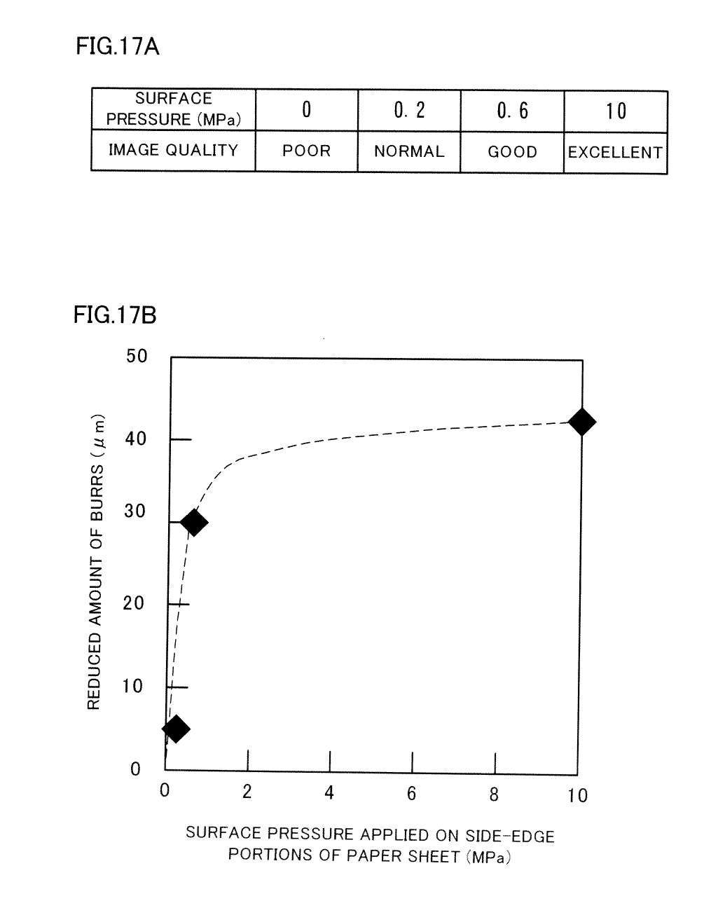

FIG. 17A is a table showing the evaluation results on the images by visual observation. FIG. 17B is a graph showing the relationship between the surface pressure applied on the side-edge portions of the paper sheet P and the reduced amount of the burrs PB (see FIG. 4). The reduced amount of the burrs PB is obtained by wrapping each one of the paper sheets P—one of the paper sheet P is before passing through the paper-sheet deburring unit 80 and another one of the paper sheet P is after passing therethrough—around a cylindrical member, and then by measuring the surface profile by use of a Surfcom manufactured by Tokyo Seimitsu Co., Ltd.

The results of the visual observation are shown in FIG. 17A. With 0.2 MPa surface pressure, the scratches on the surface of the fixing roll produces observable streaks of unevenly fixed toners. The streaks in the case of 0.2 MPa surface pressure are reduced (the image quality is labeled as “normal” in FIG. 17A) from those in the case where no paper-sheet deburring unit 80 was used (the image quality is labeled as “poor” in FIG. 17A). With a 0.6 MPa surface pressure, the steaks become less observable (the image quality is labeled as “good” in FIG. 17A). Furthermore, with a 10 MPa surface pressure, hardly any streaks are observable (the image quality is labeled as “excellent” in FIG. 17A).

Now, refer to FIG. 17B illustrating the relationship between the surface pressure and the reduced amount of the burrs PB. With a surface pressure of 0.6 MPa or higher, the burrs PB is reduced by 30 μm or more. This indicates that applying a surface pressure of 0.6 MPa or higher on the side-edge portions of the paper sheet P flattened the burrs PB of the paper sheet P, and that the fixing roll becomes less likely to be scratched.

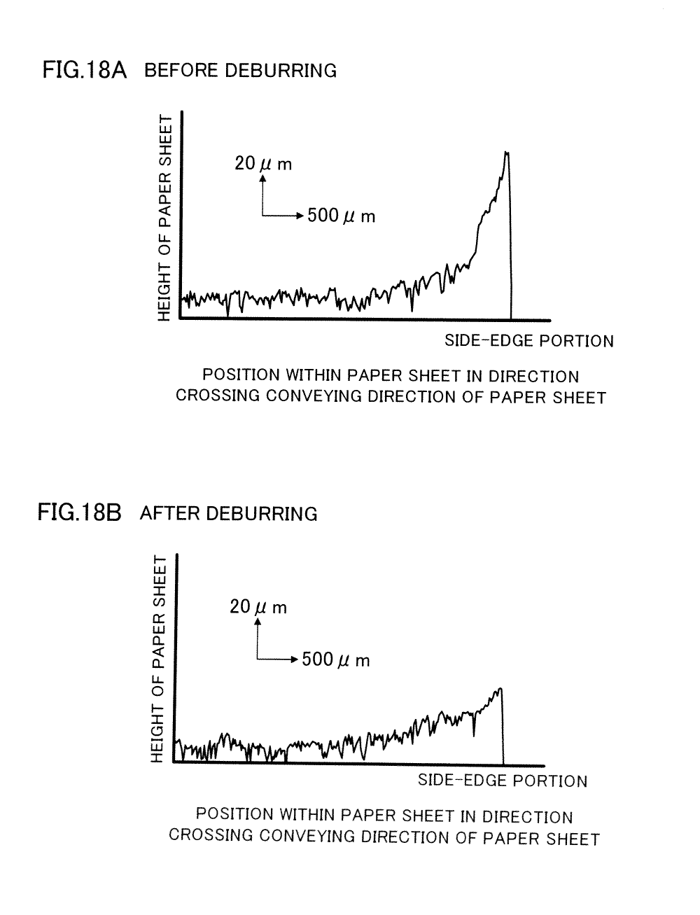

FIGS. 18A and 18B describe the height of the burrs PB of the paper sheet P before and after the paper sheet P passes through the paper-sheet deburring unit 80. FIG. 18A describes the case of the paper sheet P before deburring, that is, before the paper sheet P passes through the paper-sheet deburring unit 80. FIG. 18B describes the case of the paper sheet P after the deburring, that is, after the paper sheet P passes through the paper-sheet deburring unit 80. Both in FIG. 18A and in FIG. 18B, plotted on the horizontal axis is the position within the paper sheet P in a direction crossing the transporting direction of the paper sheet P (the position within the paper-sheet) while the height of the paper sheet P is plotted on the vertical axis. The paper sheet P used here is Digital Color Xpressions 98 Cover (216 g/m²) manufactured by Xerox Corporation. A 10 MPa surface pressure is applied on the side-edge portions of the paper sheet P in the paper-sheet deburring unit 80.

FIG. 18 clearly shows that by making the paper sheet P pass through the paper-sheet deburring unit 80, the height of the burrs PB of the paper sheet P is reduced. In this example, approximately a 40 μm reduction is achieved in the height of the burrs PB in the side-edge portions of the paper sheet P (see FIG. 17). Similar results are obtained in the cases of the paper-sheet deburring units 80 described in the second to the sixth exemplary embodiments.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A recording medium deburring apparatus, comprising:
a transporting device that transports a recording medium; and
a pressure applying device that applies pressure to edge portions of the recording medium, the edge portions being in parallel to a transporting direction of the recording medium transported by the transporting device.

2. The recording medium deburring apparatus according to claim 1, wherein the pressure applying device applies a surface pressure of 0.6 MPa or higher to the edge portions of the recording medium.

3. A recording medium deburring apparatus comprising:
a transporting member that transports a recording medium while the transporting member is rotated by given driving force; and
a counter member that is opposed to the transporting member with edge portions of the recording medium being nipped in between, the edge portions being in parallel to a transporting direction of the recording medium,
wherein the recording medium is transported between the transporting member and the counter member.

4. The recording medium deburring apparatus according to claim 3, wherein the recording medium is transported while the counter member is also rotated by given driving force.

5. The recording medium deburring apparatus according to claim 3, wherein the counter member comprises:
a first counter member that is arranged as being opposed to one of the edge portions of the recording medium; and
a second counter member that is arranged as being opposed to the other of the edge portions of the recording medium.

6. The recording medium deburring apparatus according to claim 3, wherein at least any one of the counter member and the transporting member has a slant with respect to a plane surface of the recording medium.

7. The recording medium deburring apparatus according to claim 3, further comprising:
a removing member that removes adhesion material attached to the transporting member.

8. An image forming apparatus comprising:
a transporting device that transports a recording medium;
a deburring device that corrects burrs existing in edge portions of the recording medium, the edge portions being in parallel to a transporting direction of the recording medium transported by the transporting device; and
a fixing device that fixes an image formed on the recording medium having been deburred by the deburring device.

9. The image forming apparatus according to claim 8, further comprising:
an image forming device that forms an image on the recording medium before the recording medium is supplied to the fixing device,
wherein the deburring device supplies the recording medium that has been deburred to the image forming device.

10. The image forming apparatus according to claim 9, further comprising:
an adjusting device that adjusts the relative position of the recording medium to the image forming device,
wherein the deburring device supplies the recording medium that has been deburred to the adjusting device.

11. The image forming apparatus according to claim 8, wherein the deburring device applies a surface pressure of 0.6 MPa or higher to the edge portions of the recording medium.

12. The image forming apparatus according to claim 8, wherein
the deburring device comprises:
a transporting member that transports the recording medium while the transporting member is rotated by given driving force; and
a counter member that is opposed to the transporting member with the edge portions of the recording medium being nipped in between, the edge portions being in parallel to a transporting direction of the recording medium, and
the recording medium is transported between the transporting member and the counter member.

13. The image forming apparatus according to claim 12, further comprising:
a changing device that changes the distance between the counter member and the transporting member in accordance with the size of the recording medium being transported by the transporting device.
